(19) United States
(12) Patent Application Publication
(10) Pub. No.: US 2025/0238836 A1
(43) Pub. Date: Jul. 24, 2025

(54) POWER LOSS FUNCTION FOR TRAINING A MACHINE LEARNING MODEL

(71) Applicant: Huawei Telekomünikasyon Dis Ticaret Ltd. Sti., Istanbul (TR)

(72) Inventor: Ergun Bicici, Istanbul (TR)

(21) Appl. No.: 18/421,711

(22) Filed: Jan. 24, 2024

(51) Int. Cl. G06Q 30/0242

(52) U.S. Cl. CPC G06Q 30/0242

(57) ABSTRACT

A method for training a machine learning (ML) model is provided. The method comprises: receiving a batch from a dataset to train the ML model; computing, based on predictions by the ML model on the batch from dataset, a first loss using a first loss function, wherein the first loss function comprises a term that calculates a natural logarithm of a prediction probability to a power of β, where β is a tunable parameter and is a real number, and updating weights in the ML model based on the first loss.

### TECHNICAL FIELD

This disclosure relates generally to computing technologies and, more specifically, to the training of machine learning models.

### BACKGROUND

Click-through rate (CTR) in online advertising represents a percentage of impressions of advertisements that are actually clicked on by users. CTR prediction models are used to predict whether the user will click on an advertisement or not after being shown the advertisement (referred to as an impression) in an effort to present impressions to those users that have a higher likelihood of clicking on the advertisement. In some cases, datasets used for training and testing CTR prediction models are typically unbalanced, as the impressions that actually result with clicks can be as very low, for example 2% to 10%. This is a very common scenario that is encountered also in anomaly detection.

As is widely recognized, employing an unbalanced training dataset for model training can result in various drawbacks and limitations. For instance, a model trained on an unbalanced dataset may exhibit bias toward the majority class due to its greater number of instances for learning. Moreover, the model may struggle to perform well on new, unseen data, especially for underrepresented classes, as it lacks sufficient exposure to minority examples during training. Other issues include challenges in setting thresholds, accuracy metrics that may be misleading due to inadequate representation of the minority class, and more.

In light of these challenges, there is a need to design more effective and efficient training of machine learning models.

### SUMMARY

In an example embodiment, the present disclosure provides a method for training a machine learning (ML) model. The method comprises: receiving a batch from a dataset to train the ML model; computing, based on predictions by the ML model on the batch from dataset, a first loss using a first loss function, wherein the first loss function comprises a term that calculates a natural logarithm of a prediction probability to a power of β, where β is a tunable parameter and is a real number; and updating weights in the ML model based on the first loss.

In a further embodiment, the method further comprises: computing, based on predictions by the ML model on a second dataset for validation, a second loss using a second loss function; determining, based on the second loss, convergence of the ML model; and output the ML model based on determining that the ML model is converged.

In a further embodiment, the second loss function is the same as the first loss function. Alternatively, the second loss function is different from the first loss function.

In a further embodiment, the first loss function causes a reduced loss for a respective prediction of the predictions with a corresponding probability above a predetermined threshold. The first loss function causes an increased loss for a respective prediction of the predictions with a corresponding probability below the predetermined threshold. The predetermined threshold is obtained based on a comparison between the first loss function and a cross entropy (CE) loss function without the power term β.

In a further embodiment, the second dataset is different from the batches from the training dataset.

In a further embodiment, the first loss function is a power cross entropy (PCE) loss function, expressed by: [symbol] _{PCE}(pₜ, β)=−log pₜ^{β} due to notational convenience, where p∈[0,1] is the predicted probability for a first class associated with the dataset,

$${p}_{t} = \{ \begin{matrix}p & if y = 1 \\ 1 - p & otherwise\end{matrix} ,$$

and log is the natural logarithm operation. Thus:

$${ℒ}_{PCE} ( p , β ) = \{ \begin{matrix}- log {p}^{β} & if y = 1 \\ - log ( 1 - {p}^{β} ) & otherwise\end{matrix} .$$

In a further embodiment, the first loss function is a power focal loss (PFL) loss function, expressed by: [symbol] _{PFL,α}_{ₜ}(pₜ, γ, β, αₜ)=−αₜ(1−pₜ)^{γ} log pₜ^{β}, where αₜ and γ are tunable parameters, p∈[0,1] is the predicted probability for a first class associated with the dataset,

$${p}_{t} = \{ \begin{matrix}p & if y = 1 \\ 1 - p & otherwise\end{matrix} ,$$

log is the natural logarithm operation.

In a further embodiment, the ML model is trained for predicting click-through-rate (CTR) for online advertising, and the CTR indicates a percentage of impressions of advertisements that are actually clicked on by users.

In a further embodiment, the dataset comprises samples with binary values, and wherein a value of “0” indicates a non-click prediction, and a value of “1” indicate a click prediction.

In a further embodiment, the number of samples with a value “1” in the dataset is smaller than the number of samples with a value “0” by a threshold multiple.

In a further embodiment, the dataset comprises a plurality of samples labeled with a plurality of classes, and first samples of the plurality of samples associated with a first class of the plurality of classes are significantly fewer than second samples of the plurality of samples associated with a second class of the plurality of classes.

In a further embodiment, the method further comprises: determining a first value for the tunable parameter β in the first loss function for training the ML model; and adjusting the tunable parameter β in the first loss function from the first value to a second value during training of the ML model.

In a further embodiment, the first loss function further comprises one or more other tunable parameters different from the tunable parameter β. The method further comprises: determining third values for the one or more other tunable parameters in the first loss function for training the ML model; and adjusting the one or more other tunable parameters in the first loss function from the third values to fourth values during training of the ML model.

In a further embodiment, The method further comprises: dynamically adjusting at least one of the tunable parameter β and the one or more other tunable parameters in the first loss functions at different stages of the training.

In another example embodiment, the present disclosure provides a non-transitory computer-readable medium, having computer-executable instructions stored thereon for training a machine learning (ML) model. The computer-executable instructions, when executed by one or more processors, causing the one or more processors to perform operations comprising: receiving a batch from a dataset to train the ML model; computing, based on predictions by the ML model on the batch from dataset, a first loss using a first loss function, wherein the first loss function comprises a term that calculates a natural logarithm of a prediction probability to a power of β, where β is a tunable parameter and is a real number; and updating weights in the ML model based on the first loss.

In yet another example embodiment, the present disclosure provides a system for training a machine learning (ML) model comprising: one or more memories storing instructions; and one or more processors. The one or more processors are configured to execute the instructions to cause the apparatus to train a machine learning (ML) model by performing operations comprising: receiving a batch from a dataset to train the ML model; computing, based on predictions by the ML model on the batch from dataset, a first loss using a first loss function, wherein the first loss function comprises a term that calculates a natural logarithm of a prediction probability to a power of β, where β is a tunable parameter and is a real number; and updating weights in the ML model based on the first loss.

### BRIEF DESCRIPTION OF THE DRAWINGS

FIG. 1A illustrates an example network environment, according to one embodiment.

FIG. 1B illustrates an example computer system, according to one embodiment.

FIG. 2 is a flowchart illustrating an example process for training a machine learning (ML) model, in accordance with one or more example embodiments of the present disclosure.

FIG. 3A is a plot comparing loglosses of cross entropy (CE) and power cross entropy (PCE) loss functions, in accordance with one or more embodiments.

FIG. 3B is a plot comparing loglosses of CE, focal loss (FL), and power focal loss (PFL) loss functions, in accordance with one or more embodiments.

FIG. 4 is an example system for training a ML model, in accordance with one or more example embodiments of the present disclosure.

FIG. 5 is an example process for training a ML model, in accordance with one or more example embodiments of the present disclosure.

### DETAILED DESCRIPTION

Embodiments of the present disclosure provide power loss functions for training machine learning (ML) models (e.g., neural network models). The power loss functions may guide the ML models to give more weight to the more difficult, less common instances and less weight to easy, more common instances, thereby allowing the model to converge more efficiently and effectively. In some examples, a system or apparatus implementing the power loss functions may enable dynamic adjustment during training of the ML models. For example, one or more tunable parameters in the power loss functions may be dynamically adjusted during training to further improve the training performance.

The techniques disclosed herein are applicable to any ML model and prediction tasks, such as image classification or CTR prediction as examples. It will be appreciated that the power loss functions disclosed herein may be utilized alone or in combination with existing techniques for training of ML models.

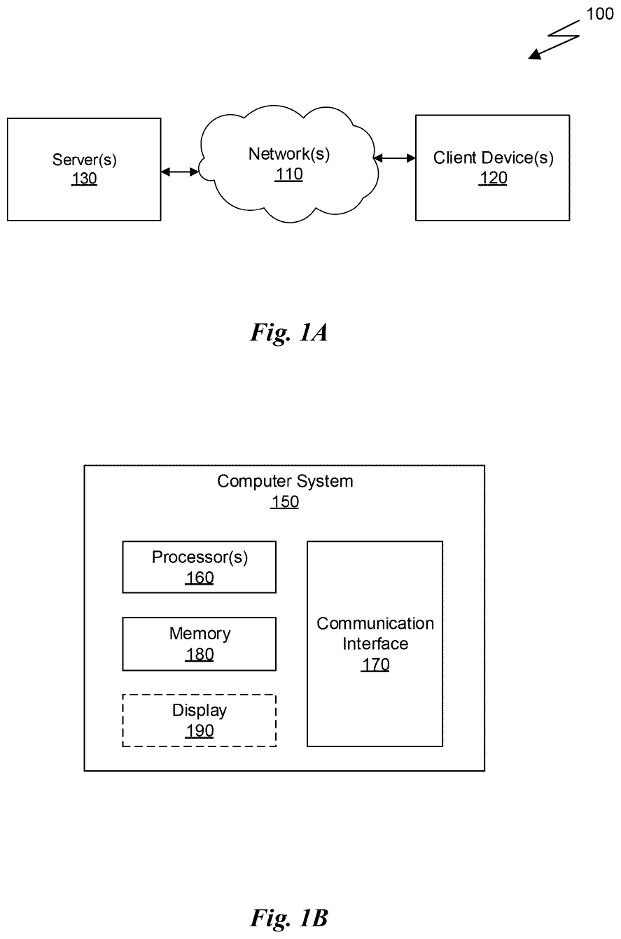

FIG. 1A illustrates an example network environment 100. A CTR prediction system implementing a prediction model according to example embodiments of the present disclosure may be implemented using the network environment 100. It will be recognized by those skilled in the art that the prediction model may be implemented in other suitable machine learning-based platform/engine for any other suitable applications. Network environments suitable for use in implementing embodiments of the disclosure may include one or more client devices 120, servers 130, and/or other device types.

Components of a network environment 100 may communicate with each other via network(s) 110, which may be wired, wireless, or both. For example, network 110 may include one or more Wide Area Networks (“WANs”), one or more Local Area Networks (“LANs”), one or more public networks such as the Internet, and/or one or more private networks. Where the network 110 includes a wireless telecommunications network, components such as a base station, a communications tower, access points, or other components may provide wireless connectivity.

Compatible network environments may include one or more peer-to-peer network environments, where a server may be absent from a network environment. Conversely, they may involve one or more client-server network configurations, in which case one or more servers may be included in a network environment. In peer-to-peer network environments, the functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (“APIs”)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). A cloud-based network environment may be private (e.g., limited to a single organization), may be public (e.g., available to many organizations), and/or a combination thereof (e.g., a hybrid cloud environment).

Server(s) 130 and/or client device(s) 120 may include at least some of the components, features, and functionality of an example computer system 150 of FIG. 1B. By way of example and not limitation, a client device 120 may be embodied as a personal computer (“PC”), a laptop computer, a mobile device, a smartphone, a tablet computer, a virtual reality headset, a video player, a video camera, a vehicle, a virtual machine, a drone, a robot, a handheld communications device, a vehicle computer system, an embedded system controller, a workstation, an edge device, any combination of these delineated devices, or any other suitable device.

FIG. 1B illustrates a block diagram of an example computer system 150 configured to implement various functions. A CTR prediction system implementing a prediction model according to example embodiments of the present disclosure may also be implemented using the example computer system 150. In some examples, the computer system 150 may be implemented in a client device 120 or a server 130 in the network environment 100 shown in FIG. 1A. One or more computing systems 150, one or more client devices 120, one or more servers 130, or the combination thereof may form a processing system (e.g., a CTR prediction system) to perform the processes according to embodiments of the present disclosure.

As shown in FIG. 1B, the computer system 150 may include one or more processors 160, a communication interface 170, a memory 180, and (optionally) a display 190. The processor(s) 160 may be configured to perform the operations in accordance with the instructions stored in the memory 180. The processor(s) 160 may include any appropriate type of general-purpose or special-purpose microprocessor (e.g., a central processing unit (“CPU”) or graphics processing unit (“GPU”), respectively), digital signal processor, microcontroller, or the like. The memory 180 may be configured to store computer-readable instructions that, when executed by the processor(s) 160, can cause the processor(s) 160 to perform various operations discussed herein. The memory 180 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM. Various processes/flowcharts described in terms of mathematics in the present disclosure may be realized in instructions stored in the memory 180, when executed by the processor(s) 160.

The communication interface 170 may be configured to communicate information between the computer system 150 and other devices or systems, such as the client device 120 and/or the server 130 as shown in FIG. 1A. In one example, the communication interface 170 may include an integrated services digital network (“ISDN”) card, a cable modem, a satellite modem, or a modem to provide a data communication connection. In another example, the communication interface 170 may include a local area network (“LAN”) card to provide a data communication connection to a compatible LAN. In a further example, the communication interface 170 may include a high-speed network adapter such as a fiber optic network adaptor, 10G Ethernet adaptor, or the like. Wireless links can also be implemented by the communication interface 170. In such an implementation, the communication interface 170 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

The communication interface 170 may also include various I/O (input/output) devices such as a keyboard, a mouse, a touchpad, a touch screen, a microphone, a camera, a biosensor, etc. A user may input data to the computer system 150 (e.g., a terminal device) through the communication interface 170.

The display 190 may be integrated as part of the computer system 150 or may be provided as a separate device communicatively coupled to the computer system 150. The display 190 may include a display device such as a liquid crystal display (“LCD”), a light emitting diode display (“LED”), a plasma display, or any other type of display, and provide a graphical user interface (“GUI”) presented on the display for user input and data depiction. In some embodiments, the display 190 may be integrated as part of the communication interface 170.

In some examples, the prediction model according to example embodiments of the present disclosure may include a neural network (NN). A NN includes multiple layers of interconnected nodes (e.g., perceptrons, neurons, etc.) that can be trained with enormous amounts of input data to quickly solve complex problems with high accuracy. The first layer in the NN, which receives input to the NN, is referred to as the input layer. The last layer in the NN, which produces outputs of the NN, is referred to as the output layer. Any layer between the input layer and the output layer of the NN is referred to as the hidden layer. The parameters/weights related to the NN may be stored in the memory 180 of a processing system in the form of a data structure.

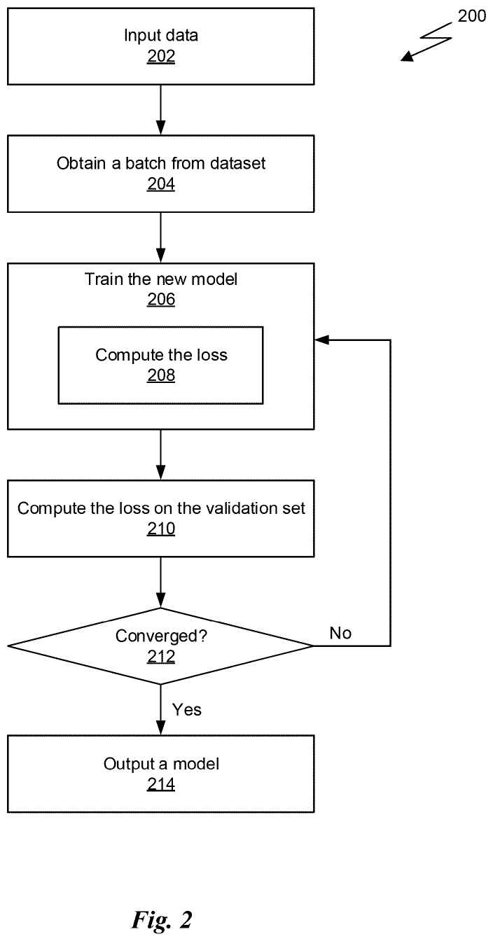

FIG. 2 is a flowchart illustrating an example process 200 for training a machine learning (ML) model, in accordance with one or more example embodiments of the present disclosure. The ML model may be implemented in a processing system operating in the network environment 110. The processing system may include one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to perform the process 200. The process 200 may be performed alone or in combination with other processes in the present disclosure. It will be appreciated by one skilled in the art that the process 200 may be performed in any suitable environment and blocks in the process 200 may be performed in any suitable order.

At block 202, the processing system obtains a dataset as input data. The dataset may take various forms suitable for training a ML model, including image data for image classification, text data for natural language processing, and user-item interaction data for recommendation systems, among others. In some examples, the input data may be sourced from a data pool, such as an item pool comprising items provided by a particular service. Various services may offer various types of items. For example, e-commerce services may provide merchandise, streaming services may provide content, and social networking services may provide online sharing, etc. In an example, the item pool may be stored locally or in the cloud in the form of big data. In another example, each item in the item pool, along with related information, may be stored in metadata.

In some instances, the processing system may randomly retrieve the dataset from the data pool or select data based on predefined or user-specific conditions to create a dataset with a specific distribution. The dataset for training may include references values (e.g., ground-truth values) indicating actual or target results.

The dataset may include unbalanced samples. For instance, a portion of the samples in the dataset may be associated with a first class (e.g., labeled with a binary value “1”), while another portion may be associated with a second class (e.g., labeled with a binary value “0”). The number of samples in the first class may be smaller than the number of samples in the second class by a threshold multiple. For example, a datasets used for training and testing a CTR prediction model may include impressions that actually result with clicks, that may range from 2% to 10% of the total impressions.

At block 204, the processing system obtains a batch from the dataset. The processing system may divide the input dataset into smaller batches. The batch size may be a parameter that determines the number of data points used in each iteration.

At block 206, the processing system trains the ML model using the batch from the dataset. Various techniques may be employed to train the ML model. As an illustrative example, without limiting the scope of the present disclosure, the processing system may perform one or more of the following operations to train the ML model.

First, the processing system may initialize the ML model with random and/or default weights and biases. The weights and/or biases are parameters that may be adjusted during training. Second, the processing system may pass the batch from the dataset through the model to obtain predictions. This step may be referred to as a forward pass, which involves applying the current model parameters (e.g., weights and/or biases) to the batch from the dataset. Third, as depicted in block 208, the processing system computes the loss. For example, the processing system may apply one or more loss functions to quantify the difference between predicted and actual values, for example, by comparing the model's predictions to the actual/target values in the dataset. The processing system may backpropagate the computed loss(es) to update one or more parameters in the model. For example, the processing system may calculate the gradients of the loss with respect to the model parameters, thereby determining the contribution of each or some of the parameters to the error. With that, the processing system may adjust one or more parameters in the model based on the computed gradients. In some instances, the processing system may apply suitable optimization algorithms (e.g., gradient descent) to adjust the one or more parameters in the model, aiming to minimize the loss and improve the model's performance. The processing system may perform multiple iterations or epochs to train the model. Each iteration may process a new or existing batch of data and updates the model parameters, gradually improving its ability to make accurate predictions.

At block 210, the processing system calculates the loss on a validation set. For example, the processing system may calculate the loss on the validation set comparing the discrepancy of the predictions with the labels. In this step, the processing system may implement block 210 to monitor the training progress. The processing system may evaluate the model on a separate dataset, referred to as a validation set, to monitor its generalization performance. This may help prevent overfitting to the training data.

At block 212, the processing system determines, based on the evaluation results, whether the trained model is converged. If not, the processing system may continue to another iteration (e.g., to perform any of blocks 204, 206, 208, 210 and/or 212). For example, the processing system may stop training when the model reaches satisfactory performance or after a predefined number of iterations or epochs.

In some examples, convergence may be determined by observing when the loss of the model on the validation set, measured by the loss function, stops decreasing significantly or starts increasing. For example, if the loss reaches a plateau or begins to rise, it suggests that the model may have converged or is overfitting. Convergence criteria may involve setting a threshold for the loss value or employing a patience parameter, which may indicate the number of iterations/epochs with no improvement before stopping the training.

At block 214, the processing system outputs a model, based on determining the convergence of the model.

Conventionally, ML models distribute the training effort on all instances equally, which causes performance degradation, computational costs, and distribution mismatch when tasks are unbalanced. To address these issues, the present disclosure provides methods for building better ML models by incorporating performance into the learning process, guiding efforts to focus on difficult instances and less on easy instances.

In some examples, the improved ML models are trained based on loss functions provided in the present disclosure. Loss functions guide ML models to focus on the most critical error for improvement. During training, one or more loss functions determine the disparity between the model outputs and the actual outputs, serving as an objective to minimize when training a ML model. For example, the weights of the model may be updated as the error is backpropagated from the outputs to the inputs. A larger error results in more substantial updates to the weights, leading to faster changes in the model. For optimizers based on gradient descent, the gradient and step size are proportional to the model's errors. As such, larger loss values will lead to larger step sizes.

In the following example, a binary classification task, such as CTR prediction, is described to demonstrate the concept of the present disclosure without limiting its applicability. For example, in a CTR prediction model, a value (or class) of “0” may indicate a non-click prediction, while a value (or class) of “1” may indicate a click prediction. It will be recognized by those skilled in the art that the techniques disclosed herein may be implemented in other types of ML models and applied to any other suitable applications.

In some ML model training implementations, cross entropy (CE) may be employed as loss function to train ML models for binary classification tasks like CTR. The CE loss function is expressed as:

$${ℒ}_{CE} ( p , y ) = \{ \begin{matrix}- log p & if y = 1 \\ - log ( 1 - p ) & otherwise\end{matrix} , \qquad ( Eq . 1 )$$

where y represents the target to predict, and p∈[0,1] is the predicted probability for class 1, log is the natural logarithm operation. When pₜ is defined as:

$${p}_{t} = \{ \begin{matrix}p & if y = 1 \\ 1 - p & otherwise\end{matrix} , \qquad ( Eq . 2 )$$

the CE loss function in Equation 1 can be rewritten as:

$${ℒ}_{CE} ( {p}_{t} ) = - log {p}_{t} . \qquad ( Eq . 3 a )$$

The benefit of CE is that it is differentiable and it is sensitive to changes in the probabilities rather than the misclassification rate and, therefore, is frequently used in optimization. For example, the gradient of [symbol] _{CE} (in Equation 3a) may be computed as:

$$\frac{\partial {ℒ}_{CE} ( {p}_{t} )}{\partial {p}_{t}} = - \frac{1}{{p}_{t}} . \qquad ( Eq . 3 b )$$

Equation 3b shows that the instances with lower confidence (e.g., with smaller probability p) are weighted larger in the gradient.

When classifying English digit images in MNIST (i.e., a large database of handwritten digitals), employing CE instead of mean squared error (MSE) results in faster training and lower classification errors for models utilizing multi-layer perceptrons (MLP). Binary CE loss is sometimes referred to as logistic loss because, to obtain probabilities from real prediction values, it is assumed that the output layer is transformed using the sigmoid or the logistic function,

$$σ ( x ) = \frac{1}{1 + exp ( - x )} ,$$

to the range [0, 1]. However, a problem with CE as a loss function is that all instances add to the loss even if the instances are easily classified (pₜ>>0.5).

Focal loss (FL) is another technique that modifies CE, aiming to reduce the loss for instances classified with high probability. For example, the classification probability above a threshold (e.g., pₜ>0.5) may be defined as high probability. FL forces the training to focus on hard to classify instances. FL may be expressed as:

$${ℒ}_{FL , {α}_{t}} ( {p}_{t} , γ , {α}_{t} ) = - {{α}_{t} ( 1 - {p}_{t} )}^{γ} log {p}_{t} , \qquad ( Eq . 4 )$$

where αₜ and γ are tunable parameters. The term (1−pₜ)^{γ} directs the training to focus on hard to classify instances. FL is designed for imbalanced datasets where, for instance, easily classified negative examples can otherwise dominate the loss. In the basic form, αₜ=1. [symbol] _{FL,α}_{ₜ} is a variant of FL that weights positive instances with αₜ and negative instances with (1−αₜ).

Neural networks (NNs) are known to be poorly calibrated due to overfitting, resulting in predicted probabilities that mismatch the actual probabilities of class labels in the data. Calibration is particularly important for NNs. The introduction of tunable parameters at and γ enables guided training of NNs to some extent. In some cases, FL can achieve better calibrated results than CE. However, further improvement is necessary as the training process becomes increasingly complex and challenging, and there is an urgent need for more efficient and effective training of ML models.

The present disclosure provides novel loss functions (referred to as power loss functions) for training machine learning models, including NNs, which give less importance to easy instances and more importance to difficult instances. For instance, the loss functions may lead the learning process to give less weight and less loss to more confident instances and focus on harder instances as confidence increases during training.

The loss functions, referred to as power loss functions, incorporate a power term to adjust the loss associated with probabilities.

In one embodiment, a power CE (PCE) loss function may be formed by incorporating a power term into the CE (e.g., in Equation 3a), expressed as:

$${ℒ}_{PCE} ( {p}_{t} , β ) = - log {p}_{t}^{β} , \qquad ( Eq . 5 )$$

where β is a tunable parameter and β is a real number. Since pₜ<1, the power term β increases the loss for β>1 and decreases it for β<1. As such, the PCE loss function incorporates a term that calculates a natural logarithm of a prediction probability (pₜ) to a power of β where

$${p}_{t} = \{ \begin{matrix}p & if y = 1 \\ 1 - p & otherwise\end{matrix}$$

for p∈[0,1], where p represents the predicted probability. Therefore:

$${ℒ}_{PCE} ( p , β ) = \{ \begin{matrix}- log {p}^{β} & if y = 1 \\ - log ( 1 - {p}^{β} ) & otherwise\end{matrix} . \qquad ( Eq . 6 )$$

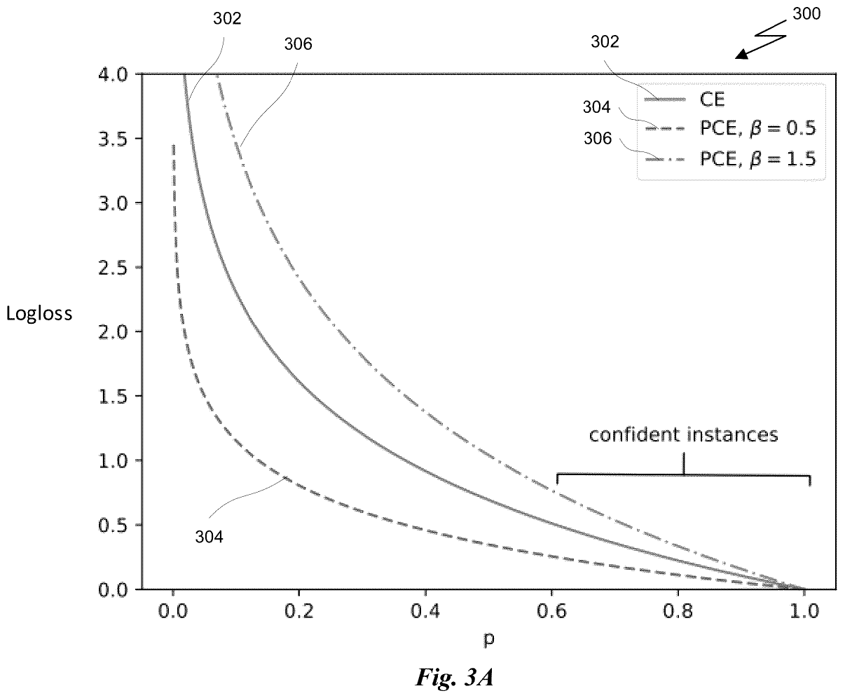

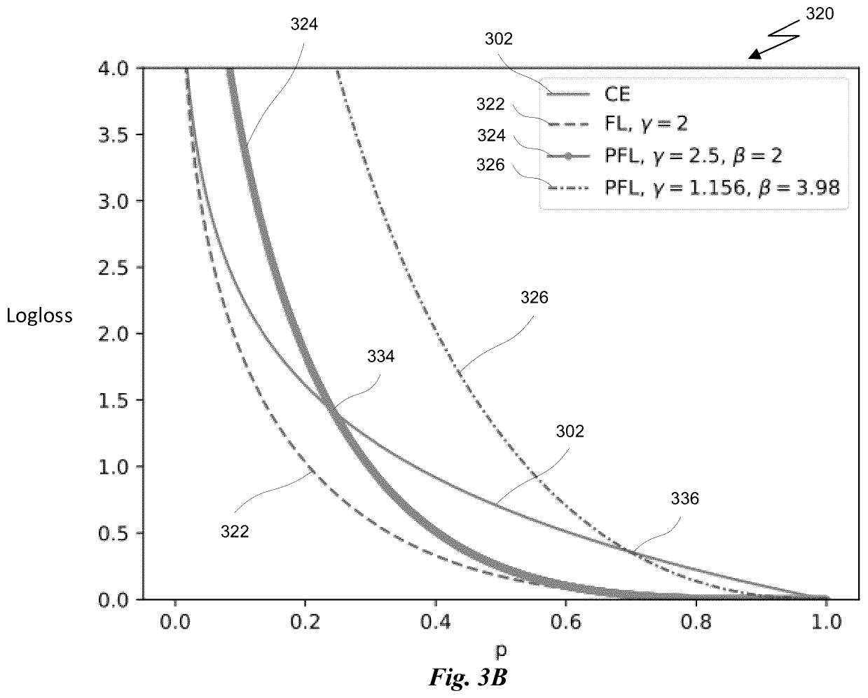

FIG. 3A is a plot 300 comparing loglosses of CE and PCE loss functions, in accordance with one or more embodiments. A logloss for CE is plotted as curve 302; whereas, loglosses for PCE loss functions are plotted as curves 304 and 306. The curve 304 corresponds to the power term β set at 0.5, and the curve 306 corresponds to the power term β set at 1.5. Confident instances are considered for values of p greater than or equal to 0.6.

Increasing the loss with PCE, as shown in FIG. 3A where β>1, guides the training towards decreasing the loss and leads the model to become more confident as the probability shifts towards a more peaked distribution. At the same time, assigning larger loss to samples with smaller confidence makes the optimizer focus on the hard samples when updating weights.

As discussed earlier, the power loss may guide training towards a more peaked distribution to result in a more substantial loss decrease, especially for p>0.5. This way, the implementation of power loss may yield sparser and more confident prediction distributions. A prediction distribution refers to the probability distribution associated with the outcomes or predictions generated by a predictive model. For example, the power loss function may be employed to shift the prediction distribution, inducing a sparser structure and, consequently, lower entropy, thereby improving calibration.

In another embodiment, the power term β may be incorporated in FL (e.g., Equation 4) to form a power focus loss (PFL) function, expressed in Equation 7:

$${ℒ}_{PFL , {α}_{t}} ( {p}_{t} , γ , β , {α}_{t} ) = - {{α}_{t} ( 1 - {p}_{t} )}^{γ} log {p}_{t}^{β} . \qquad ( Eq . 7 )$$

As shown in Equation 7, PFL has three tunable parameters, α, γ, and β, enabling lower logloss for confident instances and higher logloss for error-prone instances at the same time. Similar to the PCE, the PFL loss function also incorporates a term that calculates a natural logarithm of a prediction probability (pₜ) to a power of β.

FIG. 3B is a plot 300 comparing loglosses of CE, FL, and PFL loss functions in accordance with one or more embodiments. A logloss for CE is plotted as curve 302, a logloss for FL is plotted as curve 322, loglosses for PFL loss functions are plotted as curves 324 and 326. As indicated in the legend, the curve 322 for FL is plotted with γ=2. The curve 324 for PFL is plotted with γ=2.5 and β=2. The curve 326 for PFL is plotted with γ=1.156 and β=3.98.

As shown in FIG. 3B, compared to CE, FL (e.g., curve 322) decreases the loss (or cost) for both confident and unconfident predictions. PFL curves (324 and 326) intersect with the CE curve (302). As such, the PFL curves decrease the loss for certain predictions and increase the loss for the remaining predictions, with the division determined by the intersection points (e.g., intersection points 334 and 336). In other words, PFL may increase the cost (relative to CE) for lower probability or less confident predictions and lower the cost (relative to CE) for high probability or more confident predictions at the same time. This enhances the training confidence by assigning the cost motivating towards larger probability to high confident predictions and improves the calibration by assigning smaller loss for high probability predictions. Furthermore, a smaller loss for samples with higher confidence directs the ML training to focus towards more challenging samples (e.g., less confident samples) when updating weights. Additionally, PFL may give lower loss to instances with probabilities in the middle range (e.g., a range below a threshold for determining confident instances).

The disclosed PCE and/or PFL may be implemented in block 208 and/or block 210 to compute loss on the input batch (from block 204) and/or the validation set, respectively.

For example, referring back to FIG. 2, the processing system may employ one or more power loss functions to train the ML model. At block 208, the processing system may compute the loss by applying Equation 5 and/or Equation 7. In some examples, the processing system may receive user-input values for the tunable parameter(s) in the power loss function(s). In some instances, the processing system may automatically determine the value(s) for the tunable parameter(s) in the power loss function(s). For example, the processing system may use default values. Additionally and/or alternatively, the processing system may utilize suitable algorithms, such as one or more optimizers, to determine optimized value(s) for the parameter(s), thereby achieving target performance. In some variations, the optimized parameter(s) may be determined through experiments involving the training of models with various values (or set of values) for the parameter(s). The assessed values for the parameters can be stored in a database, allowing the processing system to retrieve a set of parameter values based on predefined conditions. In some examples, the processing system may obtain values for the tunable parameter(s) in the loss function(s) based on the distribution of the dataset batch (e.g., from block 202).

At block 210, the processing system may compute the loss by applying Equation 5 and/or Equation 7. In this step, the processing system may use the same or different loss functions compared to those used in block 208. For example, the processing system may utilize different equations and/or different values for the parameters in the loss functions implemented in blocks 208 and 210. At block 212, the processing system may determine the convergence of the trained model based on the computed loss in block 210.

In some examples, the processing system may dynamically adapt the values of the tunable parameters in the loss functions during training. For example, this adaptation may involve using different sets of values for the tunable parameters at various stages of the training process. For another example, the processing system may adjust one or more of the tunable parameters in the loss function(s) based on predetermined conditions, such as reaching a specific target performance level.

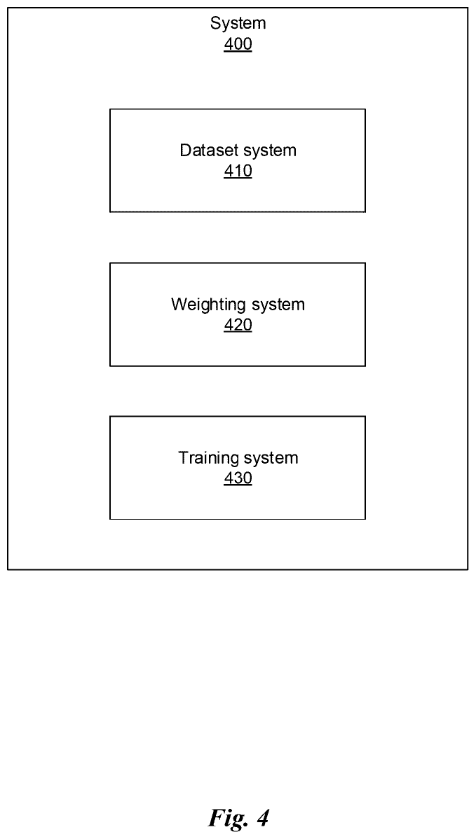

FIG. 4 is an example system 400 for training a ML model. The system 400 may include a plurality of subsystems for training the ML model. Each subsystem may include one or more computer systems 150 as illustrated in FIG. 1B, which may be embodied as one or more client devices 120, one or more servers 130, or a combination thereof in network environment 100 as depicted in FIG. 1A. Processer(s) 160 in the processing system may execute instructions stored in memory 180 to perform one or more blocks of the process 200.

As shown in FIG. 4, the system 400 includes a dataset system 410, a weighting system 420, and a training system 430.

The dataset system 410 may be configured to providing a dataset of labeled instances to the training system 430. For example, the dataset system 410 may perform block 202 and/or block 204 obtain a batch of dataset from the input data.

The training system 430 may implement one or more power loss functions (e.g., PCE or PLF) to train a machine learning model (e.g., a neural network). For example, the training system 430 may perform block 206 to apply current weights of the model for generating predictions on the input batch of dataset. Then, the training system 430 may perform block 208 to compute the loss using the one or more power loss functions and update the weights of the model based on the computed loss. After a number of iterations or epochs, the training system 430 may perform block 210 to calculate the loss on a validation set and subsequently determine the convergence of the model based on the calculated loss in block 210. Once converged, the training system 430 may output the best model (as depicted in block 214). Otherwise, the training system 430 may proceed to block 204 or block 206 to continue the training process.

The weighting system 420 may be configured to determine and/or adjust one or more tunable parameters in the one or more loss functions during training. For example, the weighting system 420 may determine and/or adjust the one or more tunable parameters in the one or more loss functions based on the distribution of the batch of input dataset (e.g., from block 202 or 204). Additionally and/or alternatively, the weighting system 420 may determine and/or adjust the one or more tunable parameters based on the difficulty of classifying each instance. For example, the weighting system 420 may adjust the one or more tunable parameters for a next iteration based on the computed loss in block 208 and/or block 210.

In one example implementation, the parameter ranges evaluated for optimizing the PCE and PFL may be [0.1, 0.9] for α, [0.1, 4] for γ, and [0.3, 4] for β. Some example implementations on a CTR dataset use β=3.982 for PCE, and use α=0.3513, γ=1.748, β=3.612 for PFL.

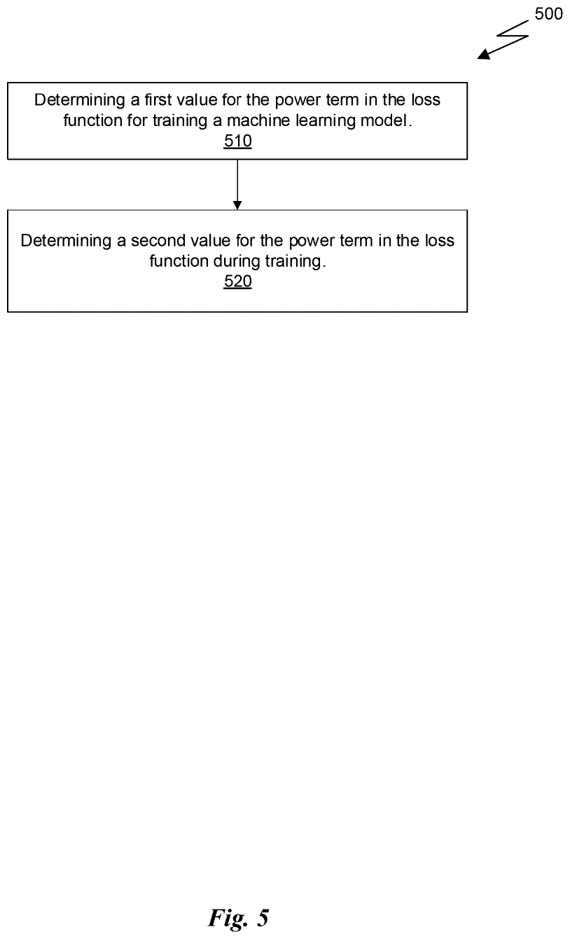

FIG. 5 is an example process 500 for training a ML model, in accordance with one or more example embodiments of the present disclosure. The ML model may be implemented in a system 400 operating in the network environment 110. The system 400 may include one or more computer systems 150 as illustrated in FIG. 1B, which may be embodied as one or more client devices 120, one or more servers 130, or a combination thereof in network environment 100 as depicted in FIG. 1A. Processer(s) 160 in the system 400 may execute instructions stored in memory 180 to perform the process 500. The process 500 may be performed alone or in combination with other processes in the present disclosure. It will be appreciated by one skilled in the art that the process 500 may be performed in any suitable environment and blocks in the process 500 may be performed in any suitable order.

The system 400 may utilize one or more power loss functions, such as PCE and/or PFL, to train the ML model. For example, the PCE may incorporate a tunable power term β (e.g., as shown in Equation 5). The PFL may include a plurality of tunable parameters, including the tunable power term β and additional parameters, such as αₜ and/or γ (e.g., as shown in Equation 7).

At block 510, the system 400 determines a first value for the power term in the loss function to train the ML model.

At block 520, the system 400 determines a second value for the power term in the loss function during training of the ML model.

The weighting system 420 in the system 400 may determine the first and second values for the power term. For example, the weighting system 420 may provide a default value as the first value to the training system 430 at the beginning of the training. Alternatively, the weighting system 420 may determine the first value based on information obtained from the dataset system 410, such as the distribution of the input data or the batch of the input dataset. The weighting system 420 may determine the second value for the power term based on the performance of the trained model, for example, based on the computed loss from block 208 and/or block 210.

In further examples, the weighting system 420 in the system 400 may perform a process similar to the process 500 to adjust other tunable parameters in the one or more loss functions during training.

The power loss functions provided in the present application can enhance training outcomes for various types of models. For example, Table 1 compares the performance of various models trained using five different loss functions, including PCE and PFL.

TABLE 1
Results comparing the performance
improvement with various models.

| | func. | loss | AUC | F1 | Precision | Recall |
|---|---|---|---|---|---|---|
| Masknet | CE | 0.39595 | 0.77606 | 0.30103 | 0.52489 | 0.21103 |
| | PCE | 0.76778 | 0.77787 | 0.39006 | 0.24822 | 0.91021 |
| | FL | 0.39224 | 0.77748 | 0.28595 | 0.53833 | 0.19577 |
| | FL_{α} | 0.39559 | 0.77612 | 0.30283 | 0.52578 | 0.21267 |
| | PFL_{α} | 0.71389 | 0.7775 | 0.40731 | 0.26525 | 0.87752 |
| DeepFM | CE | 0.3865 | 0.76825 | 0.1688 | 0.61951 | 0.09771 |
| | PCE | 0.80974 | 0.77163 | 0.36375 | 0.22471 | 0.9541 |
| | FL | 0.38675 | 0.7678 | 0.16886 | 0.6197 | 0.09775 |
| | FL_{α} | 0.38678 | 0.76777 | 0.16869 | 0.61894 | 0.09765 |
| | PFL_{α} | 0.75754 | 0.7715 | 0.37997 | 0.23881 | 0.92929 |
| DeepIM | CE | 0.38722 | 0.76701 | 0.1664 | 0.62 | 0.09609 |
| | PCE | 0.8111 | 0.76998 | 0.36282 | 0.22402 | 0.95385 |
| | FL | 0.38705 | 0.76726 | 0.16601 | 0.62079 | 0.09582 |
| | FL_{α} | 0.3872 | 0.76702 | 0.16522 | 0.62054 | 0.09529 |
| | PFL_{α} | 0.75947 | 0.76991 | 0.37902 | 0.23807 | 0.92902 |
| DCNv2 | CE | 0.38179 | 0.77719 | 0.18626 | 0.61418 | 0.10984 |
| | PCE | 0.80085 | 0.77779 | 0.36874 | 0.22859 | 0.95311 |
| | FL | 0.38167 | 0.77736 | 0.18736 | 0.61415 | 0.11056 |
| | FL_{α} | 0.38148 | 0.7777 | 0.18774 | 0.61402 | 0.11083 |
| | PFL_{α} | 0.74809 | 0.77924 | 0.38691 | 0.24439 | 0.92829 |

The models for comparison include MASKNET, DEEPFM, DEEPIM, and DCNV2. The loss functions include CE (e.g., Equation 3a), PCE (e.g., Equation 5), FL (Equation 4 where at =1), FL_{α} (Equation 4 where αₜ≠1), and PFL_{α} (Equation 7).

The metrics under comparison includes: (i) loss, indicating the divergence between the predicted values and the actual values in the training data; (ii) Area Under the Curve (AUC), indicating the probability that the model assigns a randomly selected positive instance a higher rank (e.g., more weight) than a randomly selected negative instance; (iii) F1 score, as a harmonic mean of precision and recall; (iv) precision, indicating the ratio of true positives to the total predicted positives; and (v) recall, indicating the ratio of true positives to the total actual positives.

Experiments show that both AUC and F1 metrics consistently improve when using PCE and PFL loss functions across all the experimented models. For example, the improvements in AUC reach 0.44% for DEEPFM. Improvements in AUC at 0.1% level is generally considered as significant for CTR prediction tasks. For unit improvement in AUC the power loss functions can achieve 20 times increase in CTR and each percent improvement can increase the revenue by millions of dollars each year. As such, utilizing the power loss functions to train a predictive model for CTR may lead to an increased CTR, thereby enabling increased revenue from advertisement recommendations. Furthermore, the significant improvements in F1 shows that power loss functions produce well calibrated results.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional example computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods/processes described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or example language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for training a machine learning (ML) model, comprising:
receiving a batch from a dataset to train the ML model;
computing, based on predictions by the ML model on the batch from dataset, a first loss using a first loss function, wherein the first loss function comprises a term that calculates a natural logarithm of a prediction probability to a power of β, where β is a tunable parameter and is a real number; and
updating weights in the ML model based on the first loss.

2. The method of claim 1, further comprising:
computing, based on predictions by the ML model on a second dataset for validation, a second loss using a second loss function;
determining, based on the second loss, convergence of the ML model; and
output the ML model based on determining that the ML model is converged.

3. The method of claim 2, wherein the second loss function is the same as the first loss function, or
wherein the second loss function is different from the first loss function.

4. The method of claim 1, wherein the first loss function causes a reduced loss for a first respective prediction of the predictions with a corresponding probability above a predetermined threshold, wherein the first loss function causes an increased loss for a second respective prediction of the predictions with a corresponding probability below the predetermined threshold, and wherein the predetermined threshold is obtained based on a comparison between the first loss function and a cross entropy (CE) loss function without the power term β.

5. The method of claim 2, wherein the second dataset is different from the batch from the dataset.

6. The method of claim 1, wherein the first loss function is a power cross entropy (PCE) loss function, expressed by:
$${ℒ}_{PCE} ( {p}_{t} , β ) = - log {p}_{t}^{β} ,$$
wherein p∈[0,1] is the predicted probability for a first class associated with the dataset,
$${p}_{t} = \{ \begin{matrix}p & if y = 1 \\ 1 - p & otherwise\end{matrix} ,$$
log is the natural logarithm operation, therefore:
$${ℒ}_{PCE} ( p , β ) = \{ \begin{matrix}- log {p}^{β} & if y = 1 \\ - log ( 1 - {p}^{β} ) & otherwise\end{matrix} .$$

7. The method of claim 1, wherein the first loss function is a power focus loss (PFL) loss function, expressed by:
$${ℒ}_{PFL , {α}_{t}} ( {p}_{t} , γ , β , {α}_{t} ) = - {{α}_{t} ( 1 - {p}_{t} )}^{γ} log {p}_{t}^{β} ,$$
wherein αₜ and γ are tunable parameters, p∈[0,1] is the predicted probability for a first class associated with the dataset,
$${p}_{t} = \{ \begin{matrix}p & if y = 1 \\ 1 - p & otherwise\end{matrix} ,$$
log is the natural logarithm operation.

8. The method of claim 1, wherein the ML model is trained for predicting click-through-rate (CTR) for online advertising, and wherein the CTR indicates a percentage of impressions of advertisements that are actually clicked on by users.

9. The method of claim 8, wherein the dataset comprises samples with binary values, and wherein a value of “0” indicates a non-click prediction, and a value of “1” indicate a click prediction.

10. The method of claim 9, wherein the number of samples with a value “1” in the dataset is smaller than the number of samples with a value “0” by a threshold multiple.

11. The method of claim 1, wherein the dataset comprises a plurality of samples labeled with a plurality of classes, and wherein first samples of the plurality of samples associated with a first class of the plurality of classes are significantly fewer than second samples of the plurality of samples associated with a second class of the plurality of classes.

12. The method of claim 1, further comprising:
determining a first value for the tunable parameter β in the first loss function for training the ML model; and
adjusting the tunable parameter β in the first loss function from the first value to a second value during training of the ML model.

13. The method of claim 1, wherein the first loss function further comprises one or more other tunable parameters different from the tunable parameter β, the method further comprising:
determining third values for the one or more other tunable parameters in the first loss function for training the ML model; and
adjusting the one or more other tunable parameters in the first loss function from the third values to fourth values during training of the ML model.

14. The method of claim 13, further comprising:
dynamically adjusting at least one of the tunable parameter β and the one or more other tunable parameters in the first loss functions at different stages of the training.

15. A non-transitory computer readable medium with instructions stored thereon, wherein the instructions, when executed by one or more processors, causing the one or more processors to perform operations comprising:
receiving a batch from a dataset to train the ML model;
computing, based on predictions by the ML model on the batch from dataset, a first loss using a first loss function, wherein the first loss function comprises a term that calculates a natural logarithm of a prediction probability to a power of β, where β is a tunable parameter and is a real number; and
updating weights in the ML model based on the first loss.

16. The non-transitory computer readable medium of claim 15, wherein the first loss function is a power cross entropy (PCE) loss function, expressed by:
$${ℒ}_{PCE} ( {p}_{t} , β ) = - log {p}_{t}^{β} ,$$
wherein p∈[0,1] is the predicted probability for a first class associated with the dataset,
$${p}_{t} = \{ \begin{matrix}p & if y = 1 \\ 1 - p & otherwise\end{matrix} ,$$
log is the natural logarithm operation, therefore:
$${ℒ}_{PCE} ( p , β ) = \{ \begin{matrix}- log {p}^{β} & if y = 1 \\ - log ( 1 - {p}^{β} ) & otherwise\end{matrix} .$$

17. The non-transitory computer readable medium of claim 15, wherein the first loss function is a power focus loss (PFL) loss function, expressed by:
$${ℒ}_{PFL , {α}_{t}} ( {p}_{t} , γ , β , {α}_{t} ) = - {{α}_{t} ( 1 - {p}_{t} )}^{γ} log {p}_{t}^{β} ,$$
wherein αₜ and γ are tunable parameters, p∈[0,1] is the predicted probability for a first class associated with the dataset,
$${p}_{t} = \{ \begin{matrix}p & if y = 1 \\ 1 - p & otherwise\end{matrix} ,$$
log is the natural logarithm operation.

18. The non-transitory computer readable medium of claim 15, wherein the instructions, when executed by one or more processors, causing the one or more processors to perform operations further comprising:
determining a first value for the tunable parameter β in the first loss function for training the ML model; and
adjusting the tunable parameter β in the first loss function from the first value to a second value during training of the ML model.

19. The non-transitory computer readable medium of claim 15, wherein the ML model is trained for predicting click-through-rate (CTR) for online advertising, and wherein the CTR indicates a percentage of impressions of advertisements that are actually clicked on by users.

20. An apparatus, comprising:
one or more memories storing instructions; and
one or more processors, wherein the one or more processors are configured to execute the instructions to cause the apparatus to train a machine learning (ML) model by performing operations comprising:
receiving a batch from a dataset to train the ML model;
computing, based on predictions by the ML model on the batch from dataset, a first loss using a first loss function, wherein the first loss function comprises a term that calculates a natural logarithm of a prediction probability to a power of β, where β is a tunable parameter and is a real number; and
updating weights in the ML model based on the first loss.
